(19) United States
(12) Patent Application Publication
(10) Pub. No.: US 2014/0003660 A1
(43) Pub. Date: Jan. 2, 2014

(54) HAND DETECTION METHOD AND APPARATUS

(71) Applicant: FUJITSU LIMITED, Kawasaki (JP)

(72) Inventors: Jie LENG, Shanghai (CN); Qi Wang, Shanghai (CN)

(73) Assignee: FUJITSU LIMITED, Kawasaki (JP)

(21) Appl. No.: 13/930,773

(22) Filed: Jun. 28, 2013

(30) Foreign Application Priority Data
Jun. 29, 2012 (CN) 201210236446.5

(51) Int. Cl. G06K 9/00

(52) U.S. Cl. CPC G06K 9/00087
USPC 382/103

(57) ABSTRACT

The invention discloses a method and apparatus for hand detection, wherein the method for hand detection comprises: calculating a current skin difference image by using a previous skin image and a current skin image; calculating a first threshold by using the current skin image, calculating a fourth threshold by using the current skin difference image, and calculating a second threshold and a third threshold by using the first threshold and the fourth threshold; segmenting a foreground image from the current skin difference image by using the first to fourth thresholds; and performing hand detection taking the foreground image segmented from the current skin difference image as a search scope; in the method and apparatus for hand detection based on embodiments of the invention, searching scope of hand detection process is narrowed by foreground segmenting, so that the number of cycles needed for performing a hand detection is reduced.

### FIELD OF THE INVENTION

The invention relates to image processing, and in particular, to a method and apparatus for hand detection.

### BACKGROUND ART

Hand detection is a very essential processing step for some applications such as hand gesture recognition system. FIG. 1 shows a block diagram of a hand gesture recognition system for remote control. In the hand gesture recognition system shown in FIG. 1, firstly a video frame is obtained by using a video camera; then the obtained video frame is inputted into a processing unit to perform a hand gesture recognition; once a hand gesture is recognized as one of the pre-defined gestures, the hand gesture will become an operation command trigger for software/applications on computer/portable devices.

Hand detection is the first step of hand gesture recognition. Generally, an offline-trained LBP (Local Binary Patterns) -based Cascade Classifier would be employed to perform a hand detection. Conventional LBP-based hand detection method may perfectly ran in real-time in current personal computers; however, such method would be a great load for low power devices.

### SUMMARY OF THE INVENTION

As to the problems stated above, the invention provides a novel method and apparatus for hand detection.

A method for hand detection based on embodiments of the invention, comprising: calculating a current skin difference image by using a previous skin image and a current skin image; calculating a first threshold by using the current skin image, calculating a fourth threshold by using the current skin difference image, and calculating a second threshold and a third threshold by using the first threshold and the fourth threshold; segmenting a foreground image from the current skin difference image by using the first to fourth thresholds; and performing hand detection taking the foreground image segmented from the current skin difference image as a search scope.

An apparatus for hand detection based on embodiments of the invention, comprising: a difference acquiring unit for calculating a current skin difference image by using a previous skin image and a current skin image; a threshold calculating unit for calculating a first threshold by using the current skin image, calculating a fourth threshold by using the current skin difference image, and calculating a second threshold and a third threshold by using the first threshold and the fourth threshold; a foreground segmenting unit for segmenting a foreground image from the current skin difference image by using the first to fourth thresholds; and a detection performing unit for performing hand detection taking the foreground image segmented from the current skin difference image as a search scope.

In the method and apparatus for hand detection based on embodiments of the invention, searching scope of hand detection process is narrowed by foreground segmenting, so that the number of cycles needed for performing hand detection is reduced.

### DESCRIPTION OF THE DRAWINGS

The invention may be better understood through the following description referring to the accompanying drawings; wherein:

FIG. 1 shows a block diagram of a hand gesture recognition system for remote control;

FIG. 2 shows a block diagram of an apparatus for hand detection based on embodiments of the invention;

FIG. 3 shows a block diagram of a method for hand detection based on embodiments of the invention;

FIG. 4 shows a flow diagram of a hand detection process implemented by using the method for hand detection as shown in FIG. 3;

FIGS. 5a-5d show situations (Situations a-d) where Threshold 0 to Threshold 4 are used to perform foreground segmenting;

FIG. 6 shows a diagram of plurality of combinations of the Situations a-d; and

FIG. 7 shows a diagram of extension operation in the method for hand detection based on embodiments of the invention.

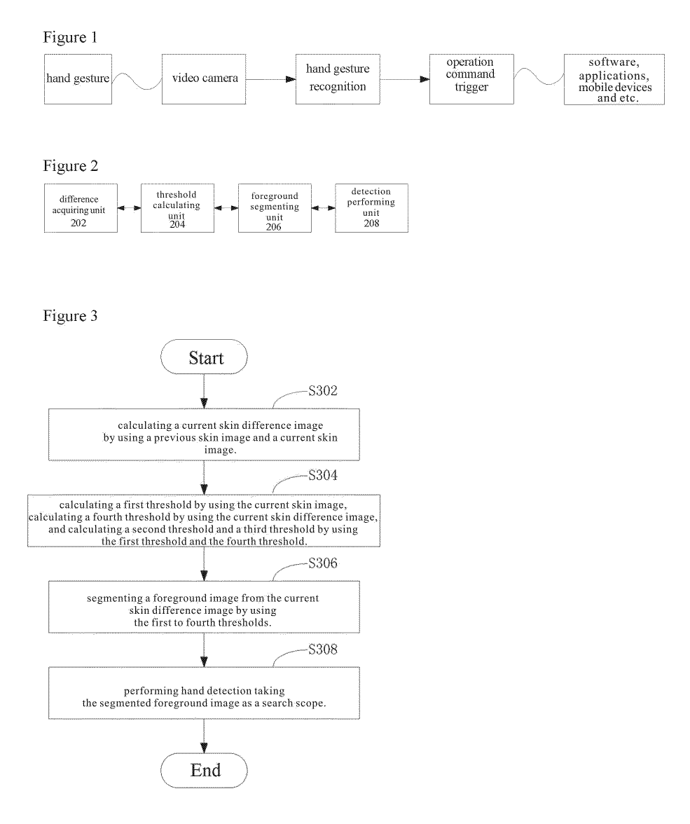

### DETAILED EMBODIMENTS

Next features and exemplary embodiments of various aspects of the invention will be described in detail. The following description covers many specific details so as to provide comprehensive understanding of the invention. However, it would be obvious for those skilled in the art that the invention may be performed in absence of some of the specific details. The following descriptions of embodiments only aim at provide clearer understanding of the invention through showing examples of the invention. The invention is not limited to any specific configurations and algorithms provided below; instead, it covers any modification, substitution, and improvement of corresponding elements, components and algorithms without departing from the spirit of the invention.

The invention provides a hand detection method and apparatus capable of running on an ultra-low-power device (an ultra-low-power device means that processing capability of the device is very limited). Specifically, the method and apparatus for hand detection based on embodiments of the invention reduce complexity of a hand detection process by finding out foreground of entire image. Currently, there are a plurality of foreground segmenting methods, but no foreground segmenting method is suitable for hand detection process on a low-power device. For example, existing “background differencing” needs a period of time to perform background modeling, it is not robust to light intensity changes and is not suitable for detecting human bodies; “bilayer segmentation of live video” proposed by Microsoft has very high computational complexity, and is not suitable for low-power devices, either.

FIG. 2 shows a block diagram of an apparatus for hand detection based on embodiments of the invention. FIG. 3 shows a block diagram of a method for hand detection based on embodiments of the invention. Next references will be made to FIG. 2 and FIG. 3 to describe the method and apparatus for hand detection based on embodiments of the invention in detail.

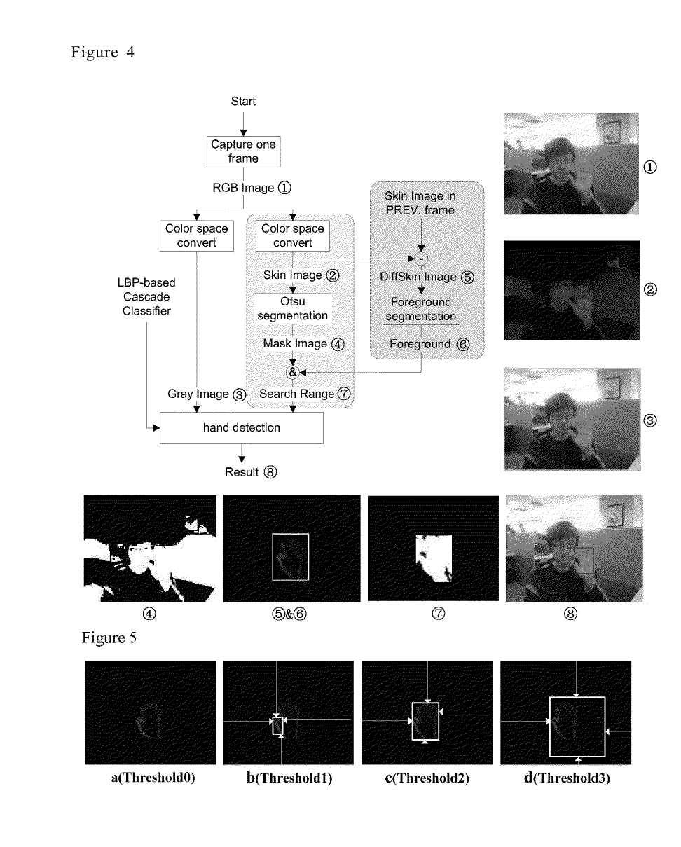

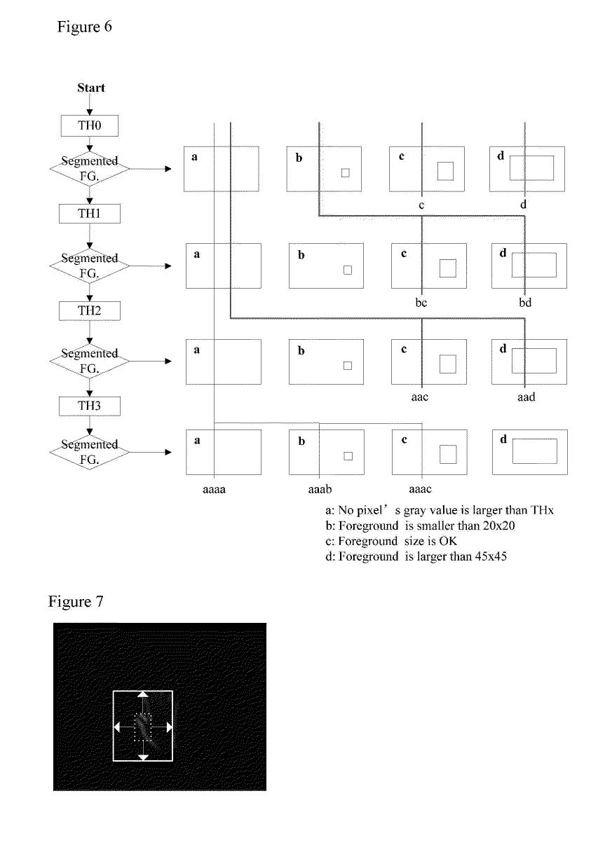

As shown in FIG. 2, the apparatus for hand detection based on embodiments of the invention comprises a difference acquiring unit 202, a threshold calculating unit 204, a foreground segmenting unit 206 and a detection performing unit 208. Wherein the difference acquiring unit 202 is for calculating a current skin difference image by using a previous skin image and a current skin image (i.e., performing Step S302); the threshold calculating unit 204 is for calculating a first threshold by using the current skin image, calculating a fourth threshold by using the current skin difference image, and calculating a second threshold and a third threshold by using the first threshold and the fourth threshold (i.e., performing Step S304); the foreground segmenting unit 206 is for segmenting a foreground image from the current skin difference image by using the first to fourth thresholds (i.e., performing Step S306); and the detection performing unit 208 is for performing hand detection taking the foreground image segmented from the current skin difference image as a search scope (i.e., performing Step S308). In conventional LBP-based hand detection methods, only gray image and cascade classifier are used for detection and the whole image needs to be checked, so that the processing is computational complex. It was proposed by some people that not all the pixels in the image need to be checked; only the ones whose color is skin or skin-like could be the checking center of one hand. FIG. 4 shows a flow diagram of a hand detection process implemented by using the method for hand detection as shown in FIG. 3 (wherein the initial image (i.e., RGB image) and converted images such as skin image, gray image, mask image, skin difference image, foreground image and search scope image). As shown in FIG. 4, in specific hand detection process, firstly, an RGB image is converted into a skin image by using formulas (1)-(3); then Otsu segmentation is used to segment the skin-like area and un-skin-like area adaptively (i.e., using Otsu segmentation to convert a skin image into a mask image); meanwhile a current skin difference image is calculated by using a previous skin image and a current skin image through subtraction, and segment a foreground image from the current skin difference image; then perform logic “AND” operation on the mask image and the foreground image to obtain a search scope of hand detection; finally perform hand detection on the gray image using the search scope to obtain result of the hand detection.

Temp=r−((g+b)>>1); (1)

Temp=MAX (0, Temp); (2)

s=Temp>140?0: Temp. (3)

In formulas (1)-(3), s indicates the value of a pixel in skin image; and r, b, g indicate the Red, Blue and Green component value of a pixel in RGB Image.

Specifically, as can be seen from figure \textcircled{4} of FIG. 4, all the white pixels will be segmented as skin area, but since skin segmenting is not so accurate, other potions are also segmented as skin area. Meanwhile since the segmented areas are still relative large, processing load for a low-power device is still heavy. Thus figure \textcircled{4} needs to be further corrected to find out the final searching area in which hand detection will be performed. According to experience, a hand can only exist in foreground, so it is reasonable and efficient to restrict the search area within foreground. The method and apparatus for hand detection based on embodiments of the invention can find the foreground accurately and efficiently. As can be seen from figure \textcircled{7} of FIG. 4, the final search range shown is much smaller than figure \textcircled{4} which means the computational complexity of the method and apparatus for hand detection based on embodiments of the invention is lower. Figure \textcircled{8} of FIG. 4 shows that the hand can be located accurately.

Next the method and apparatus for hand detection based on embodiments of the invention will be described in detail. In previous methods and apparatus for hand detection, foreground segmentation has been researched for a long time, and lots of previous work has been proved to be effective. But the method and apparatus for hand detection based on embodiments of the invention is more efficient and suitable for low power devices. Next all steps of the method and apparatus for hand detection based on embodiments of the invention will be described in detail. S302, calculating a current skin difference image by using a previous skin image and a current skin image.

Upon all the captured images are converted from RGB images into skin images, calculate difference image between adjacent images of a set of obtained skin images (i.e., calculating the absolute difference of pixel values at each positions in a current skin image and pixel values at each positions in the previous skin image, and taking an image consisting of absolute pixel value differences of pixels at the same positions of the previous skin image and the current skin image as the current skin difference image).

DiffSkin(x,y)=|PREV.Skin(x,y)−Skin(x,y)| (4)

Wherein DiffSkin(x,y) represents pixel value of a pixel (x,y) in the current skin difference image, PREV.Skin(x,y) represents pixel value of a pixel (x,y) in the previous skin image, and Skin(x,y) represents pixel value of a pixel (x,y) in the current skin image.

S304, calculating a first threshold by using the current skin image, calculating a fourth threshold by using the current skin difference image, and calculating a second threshold and a third threshold by using the first threshold and the fourth threshold. The method for hand detection based on embodiments of the invention sets four thresholds to adaptively locate the appropriate foreground in the current skin difference image (i.e., segmenting the foreground image). Specifically, a first threshold (Threshod 0) is calculated by using each pixel values of the current skin image, set a threshold that segments the current skin image using Otsu as a fourth threshold (Threshod 3) according to formula (7), then calculate a second threshold (Threshod 1) and a third threshold (Threshod 2) by using the first threshold and the fourth threshold according to formulas (8)-(9).

$$\begin{matrix} temp = \frac{{\sum }_{x = 0}^{Width - i} {\sum }_{y = 0}^{Height - i} Gray ( x , y )}{Width \times Height} & ( 5 ) \\ Threshold 0 = \frac{\sum {\sum }_{( x , y )} Gray ( x , y )}{Num} for all ( x , v ) when Gray ( x , y ) > Temp & ( 6 ) \\ Threshold 3 = Otsu ( DiffSkin ) & ( 7 ) \\ Threshold 1 = Otsu ( DiffSkin ) + ( Threshold 0 - Threshold 3 ) \times \frac{1}{3} & ( 8 ) \\ Threshold 2 = Otsu ( DiffSkin ) + ( Threshold 0 - Threshold 3 ) \times \frac{2}{3} & ( 9 )\end{matrix}$$

Wherein Skin(x,y) is pixel value of a pixel (x,y) in the current skin image, Num is the number of pixels whose gray value is bigger than temp in formula (5), Otsu (DiffSkin) means the segmentation threshold of DiffSkin image by Otsu, Width is the number of pixels contained in the width direction of the current skin image, and Height is the number of pixels contained in the height direction of the current skin image.

S306, segmenting a foreground image from the current skin difference image by using the first to fourth thresholds.

By using the thresholds in formulas (5)-(9), the foreground is searched from image edge to center (the process is shown in FIG. 3) so as to segment the final foreground image. FIG. 5a shows a situation (Situation A) where there is no pixel whose gray value is bigger than Threshold 0 in the current skin difference image. FIG. 5b shows a situation (Situation B) where parts of foreground image are captured in the current skin difference image by using Threshold 1 (i.e., there are some pixels whose gray values are bigger than Threshold 1 in the current skin difference image). FIG. 5c shows a situation (Situation C) where appropriate foreground image is captured in the current skin difference image (i.e., there are appropriate number of pixels whose gray values are bigger than Threshold 2 in the current skin difference image). FIG. 5d shows a situation (Situation D) where even the background which contains little movement is segmented as the foreground because that Threshold 3 is too small (i.e., there are too many pixels whose gray values are bigger than Threshold 3 in the current skin difference image).

FIG. 5 just shows one example that the captured foreground image of the current skin difference image becomes larger as the thresholds (Threshold 0−Threshold 3) reduced gradually. Here combination of the situations a, b, c and d is defined as (abcd). In practical application, may other combinations such as (aaaa), (aaab) and (aaac) may exist.

As shown in Table 1 below, all combinations of the situations a, b, c and d may be classified into 4 classes (“−” may represent by random one of the situations a, b, c and d): for Class 1, there exists one or more situation c, which means one or more of all the 4 thresholds can find an appropriate foreground image, the foreground image will be utilized directly; for class 2, no aforementioned situations c and d exists, which means none of the 4 thresholds can find an appropriate foreground image, in this case if foreground image in previous frame exists, the foreground image in the previous frame will be used for this frame, otherwise no foreground image will be segmented from the current skin difference image; for Class 3, no aforementioned situations b and c exists, which means the threshold is either too large or too small, so no foreground image will be segmented; and for Class 4, all combinations end up with situation d (except those who end up with “−”) and the second last situation is situation b., in this case the foreground image is taken as a foreground image which is obtained by performing appropriate extension on the foreground image found in situation b.

TABLE 1
Classification of all the situations

| | |
|---|---|
| Class 1 | (aaac), (aabc), (aac), (abbc), (abc-), (ac--), (bbbc), (bbc-), (bc--), |
| | (c---) |
| Class 2 | (aaaa), (aaab), (aabb), (abbb), (bbbb) |
| Class 3 | (d---), (ad--), (aad-), (aaad) |
| Class 4 | (aabd), (abd-), (bbbd), (bbd-), (bd--), (abbd) |

That is, when one or more foreground images having a size between 20*20 and 45*45 are segmented from the current skin difference image by using one or more of the first to fourth thresholds, taking any one of the one or more foreground images as the foreground image in the current skin difference image; when no foreground image can be segmented from the current skin difference image by using one or more of the first to fourth thresholds and foreground images having a size smaller than 20*20 are segmented from the current skin difference image by using the rest of the first to fourth thresholds, if there is a foreground image in the previous skin difference image, then taking the foreground image in the previous skin difference image as the foreground image in the current skin difference image, or else deeming that there is no foreground image in the current skin difference image; when foreground images having a size larger than 45*45 are segmented from the current skin difference image by using one or more of the first to fourth thresholds and no foreground image can be segmented from the current skin difference image by using the rest of the first to fourth thresholds, deeming that there is no foreground image in the current skin difference image; and when foreground images having a size larger than 45*45 are segmented from the current skin difference image by using one or more of the first to fourth thresholds and foreground images having a size smaller than 20*20 are segmented from the current skin difference image by using the rest of the first to fourth thresholds, firstly extending any one of the foreground images having a size smaller than 20*20, and then taking the extended foreground image as the foreground image in the current skin difference image.

FIG. 7 shows a diagram of extension operation. Specifically, the operation is to extend outward 15 pixels in up, down, left and right directions of the found foreground image having a size smaller than 20*20. 15 pixels is the optimum value obtained by size of a hand, size of an LBP trainer and experiments.

S308, performing hand detection taking the segmented foreground image as a search scope.

Specifically, upon a foreground image is segmented, the segmented foreground image is taken as the searching area, and performing hand detection process in gray image of the current frame. Additionally, if no foreground image is segmented through steps S302-S306, then no hand detection process will be performed in gray image of the current frame.

As stated above, in the method and apparatus for hand detection based on embodiments of the invention, searching scope of hand detection process is narrowed by foreground segmenting, so that the number of cycles needed for performing a hand detection is reduced. Furthermore, in the method and apparatus for hand detection based on embodiments of the invention, if no foreground image is segmented, then hand detection process is ended to save power.

The method and apparatus for hand detection based on embodiments of the invention reduces computational complexity significantly, and the whole system capable of implementing the method and apparatus for hand detection based on embodiments of the invention may partly hibernate under the condition where no foreground image is detected so as to save power.

Although the invention has been described with reference to detailed embodiments of the invention, those skilled in the art would understand that modifications, combinations and changes may be done to the detailed embodiments without departing from the scope and spirit of the invention as defined by the appended claims and the equivalents thereof.

Hardware or software may be used to perform the steps based on needs. It should be noted that under the premise of not departing from the scope of the invention, the steps may be amended, added to or removed from the flow diagram provided by the description. Generally, a flow diagram is only one possible sequence of basic operations performing functions.

Embodiments of the invention may be implemented using a general programmable digital computer, a specific integrated circuit, programmable logic devices, a field-programmable gate array, and optical, chemical, biological, quantum or nano-engineering systems, components and institutions. Generally, functions of the invention may be realized by any means known to those skilled in the art. Distributed or networked systems, components and circuits may be used. And data may be transmitted wired, wirelessly, or by any other means.

It shall be realized that one or more elements illustrated in the accompanying drawings may be realized in a more separated or more integrated method; they would even be allowed to be removed or disabled under some conditions. Realizing programs or codes capable of being stored in machine readable media so as to enable a computer to perform the aforementioned method also fails within spirit and scope of the invention.

Additionally, any arrows in the accompanying drawings shall be regarded as being exemplary rather than limiting. And unless otherwise indicated in detail, combinations of components and steps shall be regarded as being recorded when terms are foreseen as leading unclearity to the ability for separating or combining

What is claimed is:

1. A hand detection method, comprising:
calculating a current skin difference image by using a previous skin image and a current skin image;
calculating a first threshold by using the current skin image, calculating a fourth threshold by using the current skin difference image, and calculating a second threshold and a third threshold by using the first threshold and the fourth threshold;
segmenting a foreground image from the current skin difference image by using the first to fourth thresholds; and
performing hand detection taking the foreground image segmented from the current skin difference image as a search scope.

2. The hand detection method of claim 1, characterized in taking an image consisting of absolute pixel value differences of pixels at the same positions of the previous skin image and the current skin image as the current skin difference image.

3. The hand detection method of claim 1, characterized in that the processing of calculating the first threshold comprises:
calculating an average pixel value of all pixels in the current skin image;
finding out pixels, whose pixel value is larger than the average pixel value, in the current skin image;
taking an average pixel value of the pixels, whose pixel value is larger than the average pixel value, in the current skin image as the first threshold.

4. The hand detection method of claim 1, characterized in setting a threshold for segmenting the current skin difference image by Otsu as the fourth threshold.

5. The hand detection method of claim 1, characterized in when one or more foreground images having a size between 20*20 and 45*45 are segmented from the current skin difference image by using one or more of the first to fourth thresholds, taking any one of the one or more foreground images as the foreground image in the current skin difference image.

6. The hand detection method of claim 1, characterized in when no foreground image can be segmented from the current skin difference image by using one or more of the first to fourth thresholds and foreground images having a size smaller than 20*20 are segmented from the current skin difference image by using the rest of the first to fourth thresholds, if there is a foreground image in the previous skin difference image, then taking the foreground image in the previous skin difference image as the foreground image in the current skin difference image, or else deeming that there is no foreground image in the current skin difference image.

7. The hand detection method of claim 1, characterized in when foreground images having a size larger than 45*45 are segmented from the current skin difference image by using one or more of the first to fourth thresholds and no foreground image can be segmented from the current skin difference image by using the rest of the first to fourth thresholds, deeming that there is no foreground image in the current skin difference image.

8. The hand detection method of claim 1, characterized in when foreground images having a size larger than 45*45 are segmented from the current skin difference image by using one or more of the first to fourth thresholds and foreground images having a size smaller than 20*20 are segmented from the current skin difference image by using the rest of the first to fourth thresholds, firstly extending any one of the foreground images having a size smaller than 20*20, and then taking the extended foreground image as the foreground image in the current skin difference image.

9. A hand detection apparatus, comprising:
a difference acquiring unit for calculating a current skin difference image by using a previous skin image and a current skin image;
a threshold calculating unit for calculating a first threshold by using the current skin image, calculating a fourth threshold by using the current skin difference image, and calculating a second threshold and a third threshold by using the first threshold and the fourth threshold;
a foreground segmenting unit for segmenting a foreground image from the current skin difference image by using the first to fourth thresholds; and
a detection performing unit for performing hand detection taking the foreground image segmented from the current skin difference image as a search scope.

10. The hand detection apparatus of claim 9, characterized in that the difference acquiring unit takes an image consisting of absolute pixel value differences of pixels at the same positions of the previous skin image and the current skin image as the current skin difference image.

11. The hand detection apparatus of claim 9, characterized in that the threshold calculating unit calculates the first threshold by the following processing:
calculating an average pixel value of all pixels in the current skin image;
finding out pixels, whose pixel value is larger than the average pixel value, in the current skin image;
taking an average pixel value of the pixels, whose pixel value is larger than the average pixel value, in the current skin image as the first threshold.

12. The hand detection apparatus of claim 9, characterized in that the threshold calculating unit sets a threshold for segmenting the current skin difference image by Otsu as the fourth threshold.

13. The hand detection apparatus of claim 9, characterized in that when one or more foreground images having a size between 20*20 and 45*45 are segmented from the current skin difference image by using one or more of the first to fourth thresholds, the foreground segmenting unit takes any one of the one or more foreground images as the foreground image in the current skin difference image.

14. The hand detection apparatus of claim 9, characterized in that when no foreground image can be segmented from the current skin difference image by using one or more of the first to fourth thresholds and foreground images having a size smaller than 20*20 are segmented from the current skin difference image by using the rest of the first to fourth thresholds, if there is a foreground image in the previous skin difference image, then the foreground segmenting unit takes the foreground image in the previous skin difference image as the foreground image in the current skin difference image, or else the foreground segmenting unit deems that there is no foreground image in the current skin difference image.

15. The hand detection apparatus of claim 9, characterized in that when foreground images having a size larger than 45*45 are segmented from the current skin difference image by using one or more of the first to fourth thresholds and no foreground image can be segmented from the current skin difference image by using the rest of the first to fourth thresholds, the foreground segmenting unit deems that there is no foreground image in the current skin difference image.

16. The hand detection apparatus of claim 9, characterized in that when foreground images having a size larger than 45*45 are segmented from the current skin difference image by using one or more of the first to fourth thresholds and foreground images having a size smaller than 20*20 are segmented from the current skin difference image by using the rest of the first to fourth thresholds, the foreground segmenting unit firstly extends any one of the foreground images having a size smaller than 20*20, and then takes the extended foreground image as the foreground image in the current skin difference image.
